(19) United States
(12) Patent Application Publication
(10) Pub. No.: US 2021/0204516 A1
(43) Pub. Date: Jul. 8, 2021

(54) MULTI-CONTROL-MODE INTELLIGENT PET TOY VEHICLE

(71) Applicant: SHENZHEN LEBEN TECHNOLOGY CO., LTD., SHENZHEN (CN)

(72) Inventors: XUN XU, SHENZHEN (CN); ZHIPING LIU, SHENZHEN (CN)

(21) Appl. No.: 17/016,424

(22) Filed: Sep. 10, 2020

(30) Foreign Application Priority Data
Jan. 7, 2020 (CN) 2020200275306

(51) Int. Cl. A01K 15/02; A63H 30/04; A63H 31/08

(52) U.S. Cl. CPC A01K 15/025; A63H 31/08; A63H 30/04

(57) ABSTRACT

The present disclosure provides a multi-control-mode intelligent pet toy vehicle, including a body, a body frame, a multi-control assembly, a first drive wheel assembly, a second drive wheel assembly, and a guidance assembly. The multi-control-mode intelligent pet toy vehicle exchanges information with the mobile terminals or the remote controllers of the users in multiple connecting methods by the multi-control assembly. Thus, the users control the multi-control-mode intelligent pet toy vehicle by multiple control methods. The infrared sensors of the multi-control assembly detect the obstacles in the motion track of the multi-control-mode intelligent pet toy vehicle, and the infrared sensors return relevant information to the control mainboard. The control mainboard controls both the first drive wheel assembly and the second drive wheel assembly to run, thereby changing the motion track of the multi-control-mode intelligent pet toy vehicle.

### TECHNICAL FIELD

The present disclosure relates to a toy for pets, in particular to a multi-control-mode intelligent pet toy vehicle.

### BACKGROUND

As people's living standards constantly improve, raising pets has become a fashion trend of modern people. While raising pets means that people must play with the pets, thus, a large amount of toys appear on the market.

There are many toy vehicles on the market for the pets to play with, and the toy vehicles are generally divided into two types. One type of the toy vehicles is not required to be driven, and is pushed by the pets themselves. This type of the toy vehicles is simple in structure, but is not attractive enough for the pets, so that the pets have no interest in playing with this type of the toy vehicles. Another type of the toy vehicles is a remote control toy vehicle, which is required to be manually controlled by a remote controller, and is single in control and interact modes. The two types of the toy vehicles are easily rolled over, and when the toy vehicles are rolled over, the pets lose interest in playing.

### SUMMARY

The present disclosure aims at providing a multi-control-mode intelligent pet toy vehicle, which attracts pets to actively play, is not easy to roll over, and is controlled by multiple control modes.

In order to achieve object above, the present disclosure provides the multi-control-mode intelligent pet toy vehicle, including a body, a body frame, a multi-control assembly, a first drive wheel assembly, a second drive wheel assembly, and a guidance assembly. The body frame is disposed inside the body, the multi-control assembly is disposed on the body frame, the first drive wheel assembly is disposed on one side of the body frame, the second drive wheel assembly is disposed on another side of the body frame, and the guidance assembly is disposed on a top of the body. The multi-control assembly includes a control mainboard. A BLUETOOTH module, a WIFI module, a mobile network module, and a remote control module are integrated on the control mainboard. The mobile network module comprises a network card slot, and the network card slot is disposed on the control mainboard.

The body is configured to protect each component located on the body frame. The body frame is configured to dispose the multi-control assembly, the first drive wheel assembly, and the second drive assembly. The first drive wheel assembly and the second drive assembly are configured to drive the multi-control-mode intelligent pet toy vehicle. The guidance assembly is configured to attract attention of the pets. The BLUETOOTH module disposed on the control mainboard is a BLUETOOTH 4.0 module, which is connected with a BLUETOOTH module of mobile terminals such as mobile phones. The WIFI module is an embedded module, which converts a series port or Transistor-Transistor Logic (TTL) level into a WIFI wireless communication standard. A wireless network IEEE 802.11b/g/n protocol stack and a Transmission Control Protocol/Internet Protocol (TCP/IP) protocol stack are disposed inside the WIFI module. A traditional hardware device is embedded in the WWI module, and then is directly connected with the Internet by WIFI. Moreover, the traditional hardware device is connected the mobile terminals, such as the mobile phones, by a wireless local area network. The mobile network module connects the control mainboard with the mobile network by inserting a network card into the network card slot, so that the multi-control-mode intelligent pet toy vehicle is connected with the mobile terminals, such as the mobile phones, by the mobile network. The remote control module is used in conjunction with remote controllers, so that users control the multi-control-mode intelligent pet toy vehicle by the remote controllers.

Furthermore, the multi-control assembly further includes a counterweight block, a battery, a switch, and infrared sensors. The battery, the switch, and the infrared sensors are electrically connected with the control mainboard. The counterweight block is disposed on one side of the body frame, and the one side of the body frame is faced to ground. The control mainboard and the battery are disposed on the body frame. The switch is disposed on the body, and the infrared sensors are disposed on the body frame.

The multi-control assembly is configured to control a motion track of the multi-control-mode intelligent pet toy vehicle, the counterweight block keeps the multi-control-mode intelligent pet toy vehicle always in an upright state to prevent the multi-control-mode intelligent pet toy vehicle from rolling over. The control mainboard is a control component of the multi-control-mode intelligent pet toy vehicle. The control mainboard is a single-chip microcomputer or other control devices that identifies sensor signals and control other components to move. An integrated circuit (IC) chip is disposed on the control mainboard. The battery supplies necessary electric energy for other components to operate. The power switch controls an on-off of the multi-control-mode intelligent pet toy vehicle. The infrared sensors are infrared obstacle avoidance sensors, which are configured to detect obstacles in front of the multi-control-mode intelligent pet toy vehicle.

Furthermore, detection holes are disposed on the body, a position where the detection holes are disposed is coordinated and matched with a position where the infrared sensors are disposed.

The infrared sensors successfully sense the obstacles on the motion track of the multi-control-mode intelligent pet toy vehicle by the detection holes, which prevents the infrared sensors from being disturbed by a body wall.

Furthermore, the identification module includes two infrared sensors configured to detect obstacles, the two infrared sensors are electrically connected with the control mainboard. The two infrared sensors are symmetrically disposed on the front shell.

Furthermore, a charging connector is disposed on the body, and the charging connector is electrically connected with the control mainboard.

The charging connector is conveniently for the battery to charge, so that the multi-control-mode pet toy vehicle does not need to change the battery.

Furthermore, the first drive wheel assembly is identical to the second drive wheel assembly, and the first drive wheel assembly and the second drive wheel assembly are symmetrically disposed on the body frame.

The first drive wheel assembly is identical to the second drive wheel assembly, so that the multi-control-mode intelligent runs more stably, and meanwhile, a production cost is low.

Furthermore, the first drive wheel assembly includes a first motor, a first driving gear, a first driven gear, a first hub, a first tire, a first hub cover, and a first internal gear. The first motor is disposed on the one side of the body frame where the first drive wheel assembly is disposed, and the first motor is electrically connected with the control mainboard. An output shaft of the first motor is connected with the first driving gear, the first driving gear is engaged with the first driven gear, and the first driven gear is rotatably disposed on the body frame by a latch. The first driven gear is engaged with the first internal gear, the first internal gear is disposed inside the first hub, and the first hub is coaxial with the first internal gear. The first hub is rotatably disposed on the body frame, so that the first hub rotates on one side of the body. The first tire is sleeved on the first hub. The first hub cover is disposed on one side of the first hub distal to the body frame, and the first hub cover is made of a transparent material.

The first motor is a driving component of the first drive wheel assembly, which supplies power for the first drive wheel assembly. The first driving gear, the first driven gear, and the first internal gear form a gear set, and the power supplied by the first motor is transmitted to the first hub. The first hub, the first tire, and the first hub cover form a hemispherical tire, and the hemispherical tire prevents the multi-control-mode intelligent pet toy vehicle from rolling over.

Furthermore, the first drive wheel assembly further includes a first indicating lamp, the first indicating lamp is disposed on one side of the body frame close to the first drive wheel assembly, and the first indicating lamp is electrically connected with the control mainboard.

The first indicating lamp emits different light effects, the pets see the light effects of the first indicating lamp through the transparent first hub cover, so as to be attracted by the multi-control-mode intelligent pet toy vehicle.

Furthermore, the second drive wheel assembly includes a second motor, a second driving gear, a second driven gear, a second hub, a second tire, a second hub cover, and a second internal gear. The second motor is disposed on another side of the body frame where the second drive wheel assembly is disposed, and the second motor is electrically connected with the control mainboard. An output shaft of the second motor is connected with the second driving gear, the second driving gear is engaged with the second driven gear, and the second driven gear is rotatably disposed on the body frame by a latch. The second driven gear is engaged with the second internal gear, the second internal gear is disposed inside the second hub, and the second hub is coaxial with the second internal gear. The second hub is rotatably disposed on the body frame, so that the second hub rotates on one side of the body. The second tire is sleeved on the second hub. The second hub cover is disposed on one side of the second hub distal to the body frame, and the second hub cover is made of a transparent material.

The second motor is a driving component of the second drive wheel assembly, which supplies power for the second drive wheel assembly. The second driving gear, the second driven gear, and the second internal gear form a gear set, and the power supplied by the second motor is transmitted to the first hub. The second hub, the second tire, and the second hub cover form a hemispherical tire, and the hemispherical tire prevents the multi-control-mode intelligent pet toy vehicle from rolling over.

Furthermore, the second drive wheel assembly further includes a second indicating lamp, the second indicating lamp is disposed on one side of the body frame close to the second drive wheel assembly, and the second indicating lamp is electrically connected with the control mainboard.

The second indicating lamp emits different light effects, the pets see the light effects of the second indicating lamp through the transparent first hub cover, so as to be attracted by the multi-control-mode intelligent pet toy vehicle.

Furthermore, the guidance assembly includes a balance bar and an accessory. The accessory is disposed on one side of the balance bar, and another side of the balance bar is disposed on the top of the body.

The accessory is configured to attract the attention of the pets, and the balance bar is configured to support the accessory-.

Working principles and advantages of the present disclosure are as followings.

The multi-control-mode intelligent pet toy vehicle exchanges information with the mobile terminals or the remote controllers of the users in multiple connecting methods by the multi-control assembly. Thus,the users control the multi-control-mode intelligent pet toy vehicle by multiple control methods. The infrared sensors of the multi-control assembly detect the obstacles in the motion track of the multi-control-mode intelligent pet toy vehicle, and the infrared sensors return relevant information to the control mainboard. The control mainboard controls both the first drive wheel assembly and the second drive wheel assembly to run, thereby changing the motion track of the multi-control-mode intelligent pet toy vehicle. The guidance assembly attracts the attention of the pets, so that the pets catch the multi-control-mode intelligent pet toy vehicle. Thus, the multi-control-mode intelligent pet toy vehicle interacts with the pets in different ways by the multiple control methods.

### DESCRIPTION OF DRAWINGS

FIG. 1 is a perspective diagram of a multi-control-mode intelligent pet toy vehicle of the present disclosure.

FIG. 2 is an exploded diagram of the multi-control-mode intelligent pet toy vehicle of the present disclosure.

FIG. 3 is a structural schematic diagram of a first hub of the multi-control-mode intelligent pet toy vehicle of the present disclosure.

FIG. 4 is a structural schematic diagram of a second hub of the multi-control-mode intelligent pet toy vehicle of the present disclosure.

### DETAILED DESCRIPTION

Detailed description of the present disclosure is described below according to embodiments.

Reference numerals in the drawings include:

1. Body; 2. Body frame; 3. Battery; 4, Control Mainboard; 5. Counterweight block; 6. Switch; 7. Infrared sensors; 8. Balance bar; 9. Accessory; 10. Charging connector; 11. First motor; 12. First driving gear; 13. First driven gear; 14. First indicating lamp; 15. First hub; 16. First tire; 17. First hub cover; 18. First internal gear; 19. Second motor; 20. Second driving gear; 21. Second driven gear; 22. Second indicating lamp; 23. Second hub; 24. Second tire; 25. Second hub cover; 26, Second internal gear; 27. Detection holes.

The specific implementation procedure is as follows:

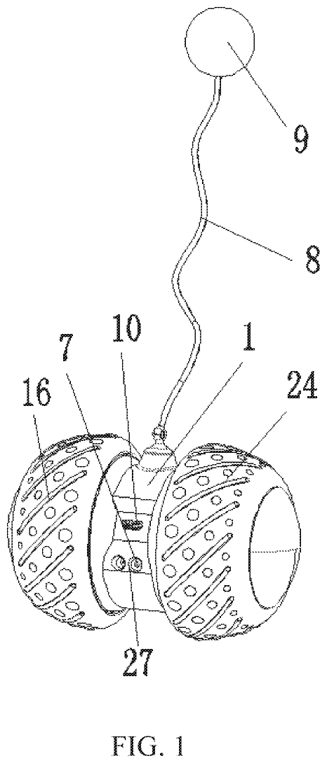

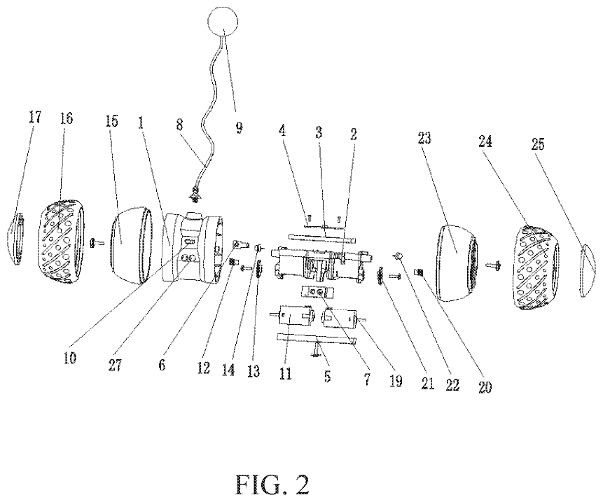

As shown in FIGS. 1-2, the present disclosure proves a multi-control-mode intelligent pet toy vehicle, including a body 1, a body frame 2, a multi-control assembly, a first drive wheel assembly, a second drive wheel assembly, and a guidance assembly. The body frame 2 is disposed inside the body 1, the multi-control assembly is disposed on the body frame 2., the first drive wheel assembly is disposed on one side of the body frame 2, the second drive wheel assembly is disposed on another side of the body frame 2, and the guidance assembly is disposed on a top of the body 1. The multi-control assembly includes a control mainboard 4. A BLUETOOTH module, a WIFI module, a mobile network module, and a remote control module are integrated on the control mainboard. The mobile network module comprises a network card slot, and the network card slot is disposed on the control mainboard 4.

The multi-control assembly includes the control mainboard 4, a counterweight block 5, a battery 3, a switch 6, and infrared sensors 7. The battery 3, the switch 6, and the infrared sensors 7 are electrically connected with the control mainboard 4. The counterweight block 5 is disposed on one side of the body frame 2, and the one side of the body frame 2 is faced to ground. The control mainboard 4 and the battery 3 are disposed on the body frame 2. The switch 6 is disposed on the body 1, and the infrared sensors 7 are disposed on the body frame 2.

When users play with pets with the multi-control-mode intelligent pet toy vehicle, firstly, the switch 6 is pressed to connect the battery 3 with the control mainboard 4, and then the multi-control-mode intelligent pet toy vehicle is turned on. After that, the multi-control-mode intelligent pet toy vehicle exchanges different control methods by the switch 6. When the switch 6 is pressed once, the multi-control-mode intelligent pet toy vehicle enters a BLUETOOTH control mode, the users install related application software in mobile terminals to connect the mobile terminals with the multi-control-mode intelligent pet toy vehicle by BLUETOOTH. When the switch 6 is pressed twice, the multi-control-mode intelligent pet toy vehicle enters a WIFI control mode, when the multi-control-mode intelligent pet toy vehicle and the mobile terminals of the users are connected with a same wireless local area network, the users control the multi-control-mode intelligent pet toy vehicle by the application software of the mobile terminals. When the switch 6 is pressed three times, the multi-control-mode intelligent pet toy vehicle enters a mobile network control mode, the multi-control-mode intelligent pet toy vehicle is connected with a wireless network by a wireless network card, then the multi-control-mode intelligent pet toy vehicle is connected with a wireless mobile network, so that the users control the multi-control-mode intelligent pet toy vehicle by the mobile network, when the multi-control-mode intelligent pet toy vehicle is used in conjunction with a camera, the multi-control-mode intelligent pet toy vehicle is further remotely operated by the users. When the switch 6 is pressed four times, the multi-control-mode intelligent pet toy vehicle enters wireless remote control mode, remote controllers of the users are connected with the remote control module disposed on the control mainboard 4, and then the multi-control-mode intelligent pet toy vehicle is controlled by the remote controllers. When the switch 6 is pressed five times, the multi-control-mode intelligent pet toy vehicle enters an irregular motion mode, when the multi-control-mode intelligent pet toy vehicle is placed on the ground, under an action of the counterweight block 5, the body 1 and the body frame 2 are always kept in a balanced vertical state when the multi-control-mode intelligent pet toy vehicle runs. Meanwhile, the control mainboard 4 controls the first drive wheel assembly and the second drive wheel assembly to run and the multi-control-mode intelligent pet toy vehicle starts the irregular motion.

As shown in FIG. 1, detection holes 27 are disposed on the body 1, a position where the detection holes 27 is disposed is coordinated and matched with a position where the infrared sensor 7 is disposed.

When the multi-control-mode intelligent pet toy vehicle runs to a position where there is an obstacle in front of the position, the infrared sensors 7 detect the obstacle through the detection holes 27 disposed on the body 1, the infrared sensors 7 return related signals to the control mainboard 4. The control main board 4 controls the first drive wheel assembly and the second drive wheel assembly to rotate in different speeds, so that a turning function of the multi-control-mode intelligent pet toy vehicle is achieved to avoid the obstacle. For example, when the infrared sensors 7 detect there is an obstacle in the front-left of the multi-control-mode intelligent pet toy vehicle which block the multi-control mode intelligent pet toy vehicle to run, the infrared sensors 7 return related signals to the control mainboard 4. Then the control mainboard 4 controls the first drive wheel assembly to run in accelerate and controls the second drive wheel assembly to run in decelerate, so that the multi-control-mode pet toy vehicle turn to right. When the multi-control-mode pet toy vehicle turns to left, the control main board controls the second drive wheel assembly to run in accelerate and controls the first drive wheel assembly to run in decelerate.

As shown in FIG. 1, a charging connector 10 is disposed on the body 1, and the charging connector 10 is electrically connected with the control mainboard 4.

When the battery 3 is insufficient in power, a charging wire is inserted into the charging connector 10, so that the battery 3 is charged.

As shown in FIG. 1, the first drive wheel assembly is identical to the second drive wheel assembly, and the first drive wheel assembly and the second drive wheel assembly are symmetrically disposed on the body frame 2.

The first drive wheel assembly is identical to the second drive wheel assembly, so that the multi-control-mode intelligent runs more stably and convenient to produce and repair, and meanwhile. Meanwhile, a production cost and repair cost are decreased.

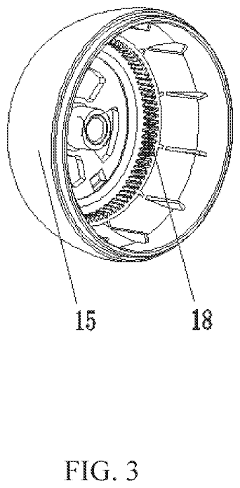

As shown in FIG. 3, the first drive wheel assembly includes a first motor 11, a first driving gear 12, a first driven gear 13, a first hub 15, a first tire 16, a first hub cover 17, and a first internal gear 18. The first motor 11 is disposed on the one side of the body frame 2 where the first drive wheel assembly is disposed, and the first motor 11 is electrically connected with the control mainboard 4. An output shaft of the first motor 11 is connected with the first driving gear 12, the first driving gear 12 is engaged with the first driven gear 13, and the first driven gear 13 is rotatably disposed on the body frame 2 by a latch. The first driven gear 13 is engaged with the first internal gear 18, the first internal gear 18 is disposed inside the first hub 15, and the first hub 15 is coaxial with the first internal gear 18. The first hub 15 is rotatably disposed on the body frame 2, so that the first hub 15 rotates on one side of the body 1. The first tire 16 is sleeved on the first hub 15. The first hub cover 17 is disposed on one side of the first hub 15 distal to the body frame 2, and the first hub cover 17 is made of a transparent material.

When the first drive wheel assembly runs, the control mainboard 4 controls the first motor 11 to start, the output shaft of the first motor 11 drives the first driving gear 12 to rotate, the first driving gear 12 is engaged with the first driven gear 13 to rotate, the first driven gear 13 is engaged with the first internal gear 18 to rotate, and the first internal gear 18 drives the first hub 15 to rotate, so that the first hub 15 rotated on one side of the body frame 2. The first hub 15 drives both the first tire 16 and the first hub cover 17 to rotate, the first hub 15, the first tire 16, and the second hub cover 17 form a hemispherical tire.

The first drive wheel assembly further includes a first indicating lamp 14, the first indicating lamp 14 is disposed on one side of the body frame 2 close to the first drive wheel assembly, and the first indicating lamp 14 is electrically connected with the control mainboard 4.

When the first hub 15, the first tire 16, and the first hub cover 17 form the hemispherical tire, and the hemispherical tire rotates, the control mainboard 4 controls the first indicating lamp 14 to blink and form light effects, the pets see the light effects through the transparent first hub cover 17, so as to be attracted by the multi-control-mode intelligent pet toy vehicle.

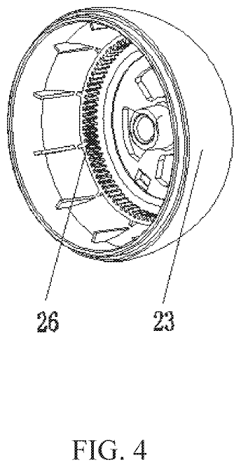

As shown in FIG. 4, the second drive wheel assembly includes a second motor 19, a second driving gear 20, a second driven gear 21, a second hub 23, a second tire 24, a second hub cover 25, and a second internal gear 26. The second motor 19 is disposed on another side of the body frame 2 where the second drive wheel assembly is disposed, and the second motor 19 is electrically connected with the control mainboard 4. An output shaft of the second motor 19 is connected with the second driving gear 20, the second driving gear 20 is engaged with the second driven gear 21, and the second driven gear 21 is rotatably disposed on the body frame 2 by a latch. The second driven gear 21 is engaged with the second internal gear 26, the second internal gear 26 is disposed inside the second hub 23, and the second hub 23 is coaxial with the second internal gear 26. The second hub 23 is rotatably disposed on the body frame 2, so that the second hub 23 rotates on one side of the body 1. The second tire 24 is sleeved on the second hub 23. The second hub cover 25 is disposed on one side of the second hub 23 distal to the body frame 2, and the second hub cover 25 is made of a transparent material.

When the second drive wheel assembly- runs, the control mainboard 4 controls the second motor 19 to start, the output shaft of the second motor 19 drives the second driving gear 20 to rotate, the second driving gear 20 is engaged with the second driven gear 21 to rotate, the second driven gear 21 is engaged with the second internal gear 26 to rotate, and the second internal gear 26 drives the second hub 23 to rotate, so that the second hub 23 rotated on one side of the body frame 2. The second hub 23 drives both the second tire 24 and the second hub cover 25 to rotate, the second hub 23, the second tire 24, and the second hub cover 25 form a hemispherical tire.

The second drive wheel assembly further includes a second indicating lamp 22, the second indicating lamp 22 is disposed on one side of the body frame 2 close to the second drive wheel assembly, and the second indicating lamp 22 is electrically connected with the control mainboard 4.

When the second hub 23, the second tire 24, and the second hub cover 25 form the hemispherical tire, and the hemispherical tire rotates, the control mainboard 4 controls the second indicating lamp 22 to blink and form light effects, the pets see the light effects through the transparent second hub cover 25, so as to be attracted by the multi-control-mode intelligent pet toy vehicle.

As shown in FIG. 1, the guidance assembly includes a balance bar 8 and an accessory 9. The accessory 9 is disposed on one side of the balance bar 8, and another side of the balance bar 8 is disposed on the top of the body 1.

The guidance assembly is disposed on the top of the body 1, when the multi-control-mode pet toy vehicle runs, the balance bar of the guidance assembly shakes and drives the accessory 9 to shake together. Shaking of the accessory 9 attracts the attention of the pets, so that the pets catch the multi-control-mode pet toy vehicle.

The multi-control-mode intelligent pet toy vehicle exchanges information with the mobile terminals or the remote controllers of the users in multiple connecting methods by the multi-control assembly. Thus, the users control the multi-control-mode intelligent pet toy vehicle by multiple control methods. The infrared sensors 7 of the multi-control assembly detect the obstacles in the motion track of the multi-control-mode intelligent pet toy vehicle, and the infrared sensors 7 return relevant information to the control mainboard 4. The control mainboard 4 controls both the first drive wheel assembly and the second drive wheel assembly to run, thereby changing the motion track of the multi-control-mode intelligent pet toy vehicle. The guidance assembly attracts the attention of the pets, so that the pets catch the multi-control-mode intelligent pet toy vehicle. Thus, the multi-control-mode intelligent pet toy vehicle interacts with the pets in different ways by the multiple control methods. Meanwhile, two wheels of the multi-control-mode intelligent pet toy vehicle is in a hemispherical shape, under the action of the counterweight block 5, the multi-control-mode intelligent pet toy vehicle prevents from rolling over.

The foregoing is merely an embodiment of the present disclosure. The specific structures and characteristics that are well known in the art, and the like, of this embodiment, are not described in detail herein. It will be appreciated by those of ordinary skill in the art that prior to the filing date or priority of the present application, all of the ordinary skill in the art can know all of the prior art in this field and have the ability to apply the conventional experimental means before the date, and one of ordinary skill in the art can refine and implement the present scheme in conjunction with its own capabilities in light of the teachings presented herein. Some typical well-known structures or well-known methods should not be an obstacle to practicing the present disclosure by one of ordinary skill in the art. It should be noted that several variations and modifications may be made to those skilled in the art without departing from the structure of the present disclosure, which should also be taken as the scope of protection of the present disclosure and do not affect the effectiveness and applicability of the practice of the invention. The scope of the invention should be set forth with reference to the claims, rather than the foregoing description of specific embodiments, which may be used to explain the contents of the claims.

What is claimed is:

1. A multi-control-mode intelligent pet toy vehicle, comprising: a body (1), a body frame (2), a multi-control assembly, a first drive wheel assembly, a second drive wheel assembly, and a guidance assembly; wherein the body frame (2) is disposed inside the body (1), the multi-control assembly is disposed on the body frame (2), the first drive wheel assembly is disposed on one side of the body frame (2), the second drive wheel assembly is disposed on another side of the body frame (2), and the guidance assembly is disposed on a top of the body (1); the multi-control assembly comprises a control mainboard (4); a BLUETOOTH module, a WIFI module, a mobile network module, and a remote control module are integrated on the control mainboard (4); the mobile network module comprises a network card slot, and the network card slot is disposed on the control mainboard (4).

2. The multi-control-mode intelligent pet toy vehicle according to claim 1, wherein the multi-control assembly further comprises a counterweight block (5), a battery (3), a switch (6), and infrared sensors (7); the battery (3), the switch (6), and the infrared sensors (7) are electrically connected with the control mainboard (4); the counterweight block (4) is disposed on one side of the body frame (2), and the one side of the body frame is faced to ground; the control mainboard (4) and the battery (3) are disposed on the body frame (2); the switch (6) is disposed on the body (1), and the infrared sensors (7) are disposed on the body frame (2).

3. The multi-control-mode intelligent pet toy vehicle according to claim 1, wherein detection holes (27) are disposed on the body (1), and a position Where the detection holes (27) are disposed is coordinated and matched with a position where the infrared sensors (7) are disposed.

4. The multi-control-mode intelligent pet toy vehicle according to claim 1, wherein a charging connector (10) is disposed on the body (1), and the charging connector (10) is electrically connected with the control mainboard (4).

5. The multi-control-mode intelligent pet toy vehicle according to claim 1, wherein the first drive wheel assembly is identical to the second drive wheel and the first drive wheel assembly and the second drive wheel assembly are symmetrically disposed on the body frame (2).

6. The multi-control-mode intelligent pet toy vehicle according to claim 1, wherein the first drive wheel assembly comprises a first motor (11), a first driving gear (12), a first driven gear (13), a first hub (15), a first tire (16), a first hub cover (17), and a first internal gear (18); the first motor (11) is disposed on the one side of the body frame (2) where the first drive wheel assembly is disposed, and the first motor (11) is electrically connected with the control mainboard (4); an output shaft of the first motor (11) is connected with the first driving gear (12), the first driving gear (12) is engaged with the first driven gear (13), and the first driven gear (13) is rotatably disposed on the body frame (2) by a latch; the first driven gear (13) is engaged with the first internal gear (18), the first internal gear (18) is disposed inside the first hub (15), and the first hub (15) is coaxial with the first internal gear (18); the first hub (15) is rotatably disposed on the body frame (2), so that the first hub (15) rotates on one side of the body (1); the first tire (16) is sleeved on the first hub (15); the first hub cover (17) is disposed on one side of the first hub (15) distal to the body frame (2), and the first hub cover (17) is made of a transparent material.

7. The multi-control-mode intelligent pet toy vehicle according to claim 6, wherein the first drive wheel assembly further comprises a first indicating lamp (14), the first indicating lamp (14) is disposed on one side of the body frame (2) close to the first drive wheel assembly, and the first indicating lamp (14) is electrically connected with the control mairiboard (4).

8. The multi-control-mode intelligent pet toy vehicle according to claim 1, wherein the second drive wheel assembly comprises a second motor (19), a second driving gear (20), a second driven gear (21), a second huh (23), a second tire (24), a second hub cover (25), and a second internal gear (26); the second motor (19) is disposed on another side of the body frame (2) where the second drive wheel assembly is disposed, and the second motor (19) is electrically connected with the control mainboard (4); an output shaft of the second motor (19) is connected with the second driving gear (20), the second driving gear (20) is engaged with the second driven gear (21), and the second driven gear (21) is rotatably disposed on the body frame (2) by a latch; the second driven gear (21) is engaged with the second internal gear (26), the second internal gear (26) is disposed inside the second hub (23), and the second hub (23) is coaxial with the second internal gear (26); the second hub (23) is rotatably disposed on the body frame (2), so that the second hub (23) rotates on one side of the body (1); the second tire (24) is sleeved on the second hub (23); the second hub cover (25) is disposed on one side of the second hub (23) distal to the body frame (2), and the second hub cover (25) is made of a transparent material.

9. The multi-control-mode intelligent pet toy vehicle according to claim 8, the second drive wheel assembly further comprises a second indicating lamp (22), the second indicating lamp (22) is disposed on one side of the body frame (2) close to the second drive wheel assembly, and the second indicating lamp (22) is electrically connected with the control mainboard (4).

10. The multi-control-mode intelligent pet toy vehicle according to claim 1, wherein the guidance assembly comprises a balance bar (8) and an accessory (9); the accessory (9) is disposed on one side of the balance bar (8), and another side of the balance bar (8) is disposed on the top of the body (1).
